(19) United States
(12) Patent Application Publication
(10) Pub. No.: US 2007/0055535 A1
(43) Pub. Date: Mar. 8, 2007

(54) System and method for funding and evaluating revenue potential of an entertainment project

(76) Inventor: Craig P. Mowry, Southampton, NY (US)

Correspondence Address: OSTROLENK FABER GERB & SOFFEN, 1180 AVENUE OF THE AMERICAS, NEW YORK, NY, 100368403, US

(21) Appl. No.: 11/517,114

(22) Filed: Sep. 6, 2006

Related U.S. Application Data
(60) Provisional application No. 60/714,275, filed on Sep. 6, 2005.
(60) Provisional application No. 60/739,354, filed on Nov. 22, 2005.

(51) Int. Cl. G06Q 99/00

(52) U.S. Cl. 705/1

(57) ABSTRACT

A system and method for receiving a financial contribution for a project from a plurality of participants in an interactive offering. Preferably, promotional media that demonstrates the project is generated, and provided to at least one of the participants. The project is preferably demonstrated to the at least one participant as a function of the promotional media. Further, a selectable control in a display screen is provided over a communication network that, when selected, represents the participant's indication to make a contribute fees for the project. The fees may be charged to the participant's cable television or satellite television bill. Further, an incentive is preferably provided to participant for contributing, wherein the financial contribution is applied to the project.

### CROSS-REFERENCE TO RELATED APPLICATION

The present application is based on and claims priority to U.S. Provisional Patent Application Ser. No. 60/714,275, filed on Sep. 6, 2005 and entitled “SYSTEM AND METHOD FOR ELICITING VIEW FEEDBACK REGARDING ENTERTAINMENT PROJECTS' VIABILITY AND ACQUIRING FRONT END FUNDING FROM SAID VIEWERS FOR THOSE PROJECTS DETERMINED TO HAVE REVENUE POTENTIAL,” and to U.S. Provisional Patent application, Ser. No. 60/739,354, filed on Nov. 22, 2005, and entitled SYSTEM AND METHOD FOR ELICITING VIEWER FEEDBACK REGARDING ENTERTAINMENT PROJECTS' VIABILITY AND ACQUIRING FRONT END FUNDING FROM SAID VIEWERS FOR THOSE PROJECTS DETERMINED TO HAVE REVENUE POTENTIAL (ADDITIONAL DISCLOSURE),” the entire contents of both of which is hereby incorporated by reference.

### BACKGROUND OF THE INVENTION

1. Field of the Invention

The present invention relates generally to entertainment production and, more particularly, to funding entertainment productions as a function of incentives provided to previewers.

2. Description of the Related Art

Typically, entertainment projects, such as distributed on television and in movie theaters, require a significant and often impractical initial financial production investment. As used herein, such initial investment is referred to as a “front end” investment, because payments have to be made initially “up-front” before an entertainment project goes into production. For a full length feature film and depending on the individual production, front end investments can be in the tens of millions of dollars. For example, it is not inconceivable that front end investments relating to the production of a science fiction film having extensive special effects will exceed one hundred million dollars to produce.

Unfortunately, returns on front end investments are often not realized once an entertainment production goes into distribution, for example, on television or in movie theaters. The return on front end investments is referred to herein, generally, as “back end investments,” and include ticket sales, numbers of viewers and corresponding advertising revenue, or the like. If the number of viewers is low, then, typically, returns on investments are not realized. Alternatively, a threat of low or no returns on front end investments often results in entertainment productions never being made. Since the threat of low back end investments results in many projects that do not get made, another result is that homogenous groups of films are created by the major film studios for cinema and even television.

### SUMMARY OF THE INVENTION

Accordingly, the present invention provides an easy way for determining with a relatively high degree of accuracy the viability of an entertainment project, while simultaneously providing funding of the project's creation on the front-end, at least in part coming from those who might be considered end users, or among the intended audience of the finished project, had the project been funded conventionally.

Accordingly, a system and method is disclosed for receiving a financial contribution for a project from a plurality of participants in an interactive offering. Preferably, promotional media that demonstrates the project is generated, and provided to at least one of the participants. The project is preferably demonstrated to the at least one participant as a function of the promotional media. Further, a selectable control in a display screen is provided over a communication network that, when selected, represents the participant's indication to make a contribute fees for the project. The fees may be charged to the participant's cable television or satellite television bill. Further, an incentive is preferably provided to participant for contributing, wherein the financial contribution is applied to the project.

In a preferred embodiment, a system and method to create a platform for testing the potential of a new entertainment project with remarkable accuracy and speed is provided. Entertainment projects having viability are rapidly financed toward production and/or distribution. Further, production and distribution channels are provided with data and financing that are typically unavailable to entities in the prior art, including major studios. Further, powerful, alluring new options for paid television and internet access subscribers are provided, while simultaneously providing layers of revenue potential.

Other features and advantages of the present invention will become apparent from the following description of the invention that refers to the accompanying drawings.

### BRIEF DESCRIPTION OF THE DRAWINGS

For the purpose of illustrating the invention, there is shown in the drawings a form which is presently preferred, it being understood, however, that the invention is not limited to the precise arrangements and instrumentalities shown. The features and advantages of the present invention will become apparent from the following description of the invention that refers to the accompanying drawings, in which:

FIG. 1 shows an example display screen that illustrates entertainment project menu; and

FIG. 2 illustrates an example scenario wherein a participant invites guests over for a home screening of an entertainment project.

### DETAILED DESCRIPTION OF EMBODIMENTS OF THE INVENTION

As noted above, an issue with most entertainment projects is whether an audience will be there to pay on the back end for the investment made on the front end. As a result, many projects do not get made and often homogenous groups of films are created by the major film studios for cinema and even television.

The present invention includes a plurality of components to enable an interactive or two-way system for communication to enable information to be sent and received to and from the public. The information is preferably related to whether the public is interested in a particular entertainment project. Unlike typical prior art entertainment projects, however, members of the public are exposed to specifically created promotional media, such as “teasers,” as known in the art, that are related to an entertainment project. As used herein, a “promotional media” refers to media, such as a visual and/or audio presentation of selectively short duration, presenting aspects and attributes in an entertaining form, such as a “movie trailer” format (typically of only a few minutes in length). Promotional media are designed to showcase value points, such as “movie stars,” and other potential project attributes and possibilities, which may factor into the entertainment and/or monetary value and potential of such potential projects. Examples of potential entertainment projects include motion pictures, TV productions, music, stage shows, concerts, or the like. The promotional media preferably provide a sampling of a potential entertainment project which is provided to a participant. The promotional media may be a movie trailer, a portion of a musical composition, a television commercial for a product, or the like, or an “animatic” or other specially prepared sequence of visuals with audio that are designed to showcase the potential project's potential attributes toward audience participation through provided interactive options. Preferably, selected members of the public are informed of a story, of respective actors/actresses, authors, music, and/or persons who are otherwise involved in an entertainment production, etc. In one example, a movie trailer is created prior to the corresponding movie being produced, prior to a script being written, and/or prior to talent signed. All that exists at the time that the selected members public are exposed is the promotional media (e.g., movie trailer).

Also as used herein, the term, “module” refers, generally, to one or more discrete components that contribute to the effectiveness of the present invention. Modules can operate or, alternatively, depend upon one or more other modules in order to function.

Preferably, members of the public who subscribe to paid television and/or internet service are invited to participate in the entertainment project promotional media evaluations, substantially as described herein. Those who elect to participate are preferably exposed to a respective promotional media and, use a device to communicate their observations. For example, an individual uses his computing device to communicate over the internet by accessing a particular web site and, using graphical display screen controls, make selections and submit information. Alternatively, the individual interacts via existing cable television/internet connectivity and hardware, such as provided by CABLEVISION, COMCAST, and the like.

In one embodiment, a cable television provider, a satellite television provider or other communications entity is affiliated with the firm that creates the promotional media (e.g., movies trailers) and packages the potential entertainment projects. By interacting, for example, via an cable television device or web browser operating on a computing device and connected to the internet, a special menu may be accessed. Preferably, the menu is preferably interactive, thereby enabling two-way communication between the a provider and a consumer.

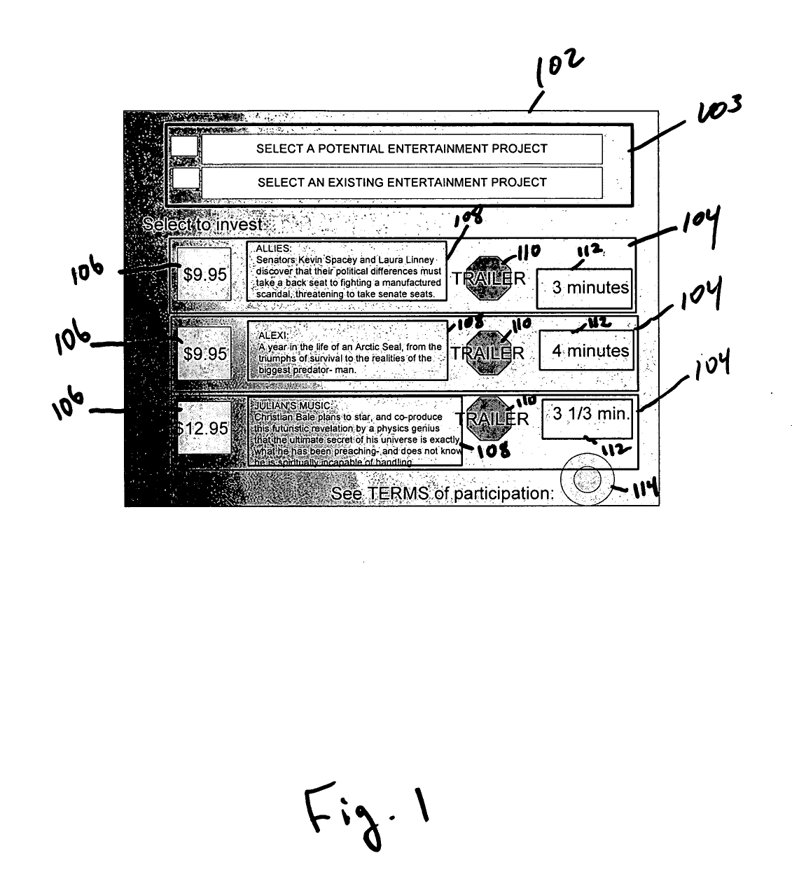

Referring now to the drawing figures in which like reference numerals refer to like elements, FIG. 1 shows an example display screen that illustrates entertainment project menu 102 providing choices that, when selected, enable a user to access respective promotional media. Users can select project choice 103 to select a potential project (not yet in production), or an existing project that may be already produced but not yet distributed. As shown in FIG. 1 options are provided not only promotional media for projects yet to be produced, but also completed projects and/or projects in progress (or other more completed projects related to entertainment) and may be provided as selectable controls (such as icons) in interactive menu 102. Thus, providers of finished or nearly finished projects may seek funding for completion, marketing and or other needs toward distribution in theaters, and/or through other venues, selectively including the cable provider, for example, providing the venue originally. This preferably removes the risk of back-end revenue for a range of projects that otherwise might not get produced and/or distributed. Further, the viewing public educates the producers and/or distributors directly as to the potential of projects. Viewers may even provide “creative decisions” related to such projects for projects that are not yet produced or for “works in progress.”

Continuing with reference to FIG. 1, project choices 104 enable a user to select a respective project. Menu 102 may be provided on various display devices, including, for example, televisions, computer monitors or other display devices. Menu 102 preferably displays fees 106 associated with choices that are charged to a user, choice descriptions 108 that briefly describe the respective entertainment projects, promotional media type description 110 that identifies the type of the promotional media (e.g., a movie trailer, a television commercial, concert footage, etc.), and promotional media length 112 that identifies the amount of time of the promotional media. Further, terms of participation are preferably provided by selecting terms control 114.

Using menu 102, a user preferably selects a choice 104 to access and/or preview a proposed entertainment project and receive exposure to the project, for example, to get a feel for a project, identify talent who would be featured (e.g., acting, performing, directing, producing, etc.) in the project, should the project get produced and distributed. The options provided in menu 102 provide promotional pieces to identify the marketing potential of the project, as well as how an entertainment project may be demonstrated and tested.

In a preferred embodiment, users are charged a fee for participating in viewing promotional media and submitting information regarding their observations. For example, when a viewer/consumer selects a project choice 104, a fee is added to the regular subscription bill (e.g., cable or satellite television, internet or other related service) that the participant subscribes or agrees to pay. In exchange for the added cost, the participant preferably receives one or more incentives. In one embodiment, the participant effectively becomes a “co-producer” in a selected promotion. Other incentives may be based on the project a participant deems to be interesting and have a high potential. Such incentives may include free PAY-PER-VIEW events, options credited to an account, or even a percentage financial return in a project. In case a percentage is offered, the percentage is preferably above and beyond cost or of gross revenue. By offering financial returns, a participant becomes a paying participant involved in a “piece of the action,” which provides a level of excitement to the incentive and the project generally. In one embodiment, such participation might occur as “credit” on subscription service fees, such as a cable television bill, to preclude a cash outlay by the host firm and/or producers of the project. Alternatively, actual revenue is realized by the participant.

Preferably, the participant is prompted for feedback in response to a respective promotional media that is viewed or otherwise enjoyed. After a promotional media is viewed, the participant preferably decides whether or not to incur the additional fee and effectively become a “partner” in the project. Selectively, incentives are provided by the host company (such as a cable or satellite television provider, internet service provider or entertainment media provider such as IFILM or NETFLIX) simply for viewing and responding to promotional media. Such feedback provides critical potential market data to the producers, educating them as to the profit potential of a given proposed project, as provided by the actual eventual paying viewers at home.

Thus, as described above and shown in the example embodiment in FIG. 1, choices for promotional media (e.g., potential entertainment project teasers) are provided as selectable icons. The promotional media are produced specifically for a respective venue and feature visuals and/or original footage of stars, in the context of these pre-production “trailers” to potential films and/or other projects being considered or approaching production. For example, independent films, or other projects, are provided in a special page/venue, that includes rough cuts and works-in-progress.

Participants preferably have an option of previewing and selecting projects and/or promotional media that represent projects the participants believe will succeed and/or find interesting. The participants incur a modest charge (e.g., $9.95) for becoming “producers” that is preferably added to their cable television bill or subscription service. Thereafter, incentives are provided. For example, in case a new independent film requiring financing toward potential distribution is selected, they could view the entire film, exclusively.

Other incentives are envisioned herein. In one embodiment, the incentive provided to a participant is the ability of a viewer to uniquely see or preview a film, preferably a “rough cut” of a film, or a portion of a film that is still in production. Such a preview is believed by the inventor to be exciting to movie enthusiasts, for example. A participant's investment is returned in “added value” by having an exclusive “preview,” for example. Another incentive includes an eventual return of credit (money) to a participant's account in case an entertainment project is never produced. Alternatively, actual money as a return on investment is provided to participants as investors. Preferably, participants are provided with options (such as selections made in a display screen) to select a respective incentive.

In accordance with yet another embodiment, a powerful incentive to participants who invest in projects that are yet-to-be produced is that the participants are provided access to a completed project on cable or satellite television, or distributed a DVD or other tangible recording, before or when the project is released in theaters and/or before the project is conventionally distributed beyond theaters. Moreover, a non-theatrically released film or project may be available to those who participated (i.e., invested a small fee and/or provided feedback) prior to the entertainment project being available more widely to non-participants on the venue, (such as PAY-PER-VIEW system(s) or cable networks of the company, such as IFC Films).

Further, participants are involved in providing feedback through various display screens to help to get promising, quality or interesting entertainment (films especially) made and/or distributed. Such projects/films that are shot and/or distributed (either over cable or satellite television, or in movie theaters) preferably results in an eventual “credit” to the participant's account, based on a flat amount or a % of revenue above cost that is shared (selectively) between the respective participants.

Preferably, PAY-PER-VIEW credit or other credit is provided for participants who provide only interactive feedback related to projects, for example, completed films that are being tested.

In order to select and participate in a potential (or other, such as produced but not distributed) entertainment project, an interactive feedback system is provided. For example, various display screens provide a virtual venue for viewer and participant feedback, and/or to tie-in with internet feedback, thereby allowing viewers to submit specific data related to finished projects they have viewed, potential projects they have viewed as teasers and then react as to “why it will or will not work or be interesting,” and related data critical to the entertainment industry.

Further, a cable television selection system (and/or other system, such as distributed via internet and or DVD distribution) display a program or new film that may be get theatrical release, prior to being returned to the cable television venue for viewing.

An advantage of the present invention is that substantial sums of revenue may be raised for a project by cable television, satellite television, or cable television subscribers by way of their digital interactive viewing system, for a film that may actually get theatrical release before being viewed even on the television system.

Thus, a powerful program for providing funding and audience, e.g., focus group data, relevant to potential project profitability is created in accordance with the teachings herein. Various distribution techniques are envisioned, such as cable TV or a venue through which the interactivity is provided, which includes internet based, mail based (DVD's sent through the mail, such as via NETFLIX) or cable television interactivity means, the program of participating in yet-to-be produced projects accomplished by providing previews and participation tools for subscribers (members and or participants).

In a preferred configuration, digital interactive cable television interactivity is provided, wherein film and/or project previews may be ordered, paid for and viewed without a need for significant additional hardware and/or programming, in order to instigate the program. After software, or other promotional media are complete, implementing the teachings herein can occur rapidly.

Preferably, investments by participants on entertainment projects films that are not produced, may be returned to their cable television (or other subscription) account for use, for example, for other PAY-PER-VIEW orders, additional promotional media, or related products.

Preferably, participants receive levels of value and interactive gratification, potential reward, and the provider of the service derives unique market (focus group) data for the entertainment industry and provides a powerful means to fund a range of entertainment projects without risk.

Even though several of the embodiments and examples described herein relate to potential entertainment projects such as movies, the invention is not so limit. Various other applications are envisioned and will be understood by one skilled in the art. For example, music concerts may be funded by viewers pre-paying (investing) in those they would like to view, including selectively the ability to participate in “profit” via credit on their account, or more directly in cash, by “participating” in the concert before it is going to happen. Indeed, the need for advertising sponsors is reduced or eliminated if a performer's concert is funded in part, or completely, or beyond its total cost, by the viewers who will eventually view the event. As described above, preferably a failed project may selectively result in the investment being returned to the participant in the form of credit for other services. This remunerates the participant and precludes little or no cash outlay to the provider and avoid loss.

The benefit of providing potential earnings, exclusive viewing rights and direct programming input to entertainment programming ensures that viewers, for example, on cable systems, would likely utilize the interactive features while the entertainment industry simultaneously enjoys a new way to create and test projects otherwise not as likely to be made and/or distributed.

Various additional features related to the present invention are envisioned. For example, within the “incentive” aspect to viewers/subscribers or Internet users, in an option direct to an internet configuration, when a home viewer partners or otherwise invests in an entertainment project, whether completed or not yet produced, he not only gets exclusive “early” viewing rights of that film when it is ready, he may get to view it in stages such as rough cut form as with typical prior art producers. His feedback may be provided during the process, along with other participants.

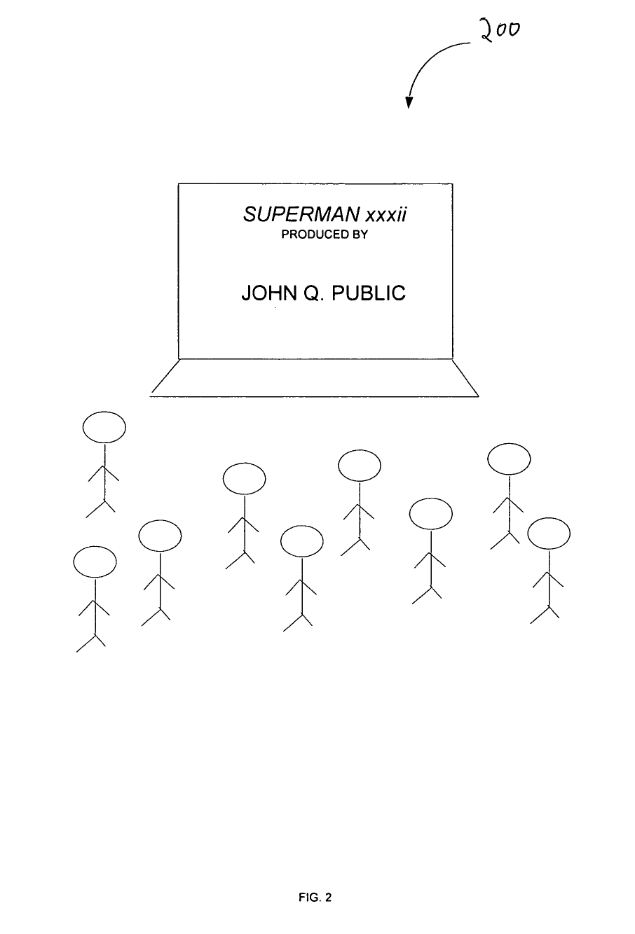

Further, a participant and his fellow participants may end up being the only ones who get to view the film/project, in case, for example, the project is never further distributed for example. Moreover, a computing device providing interactive options, such as described herein further provide selectively the insertion of the participant's name into a unique “producer slate” in the project's credits. FIG. 2 illustrates an example scenario 200 wherein a participant invites guests over for a home screening of an entertainment project, SUPERMAN XXXII. During the opening credits, the participant, John Q. Public, has his name displayed as the producer of the film. In this example, John Q. Public previously selected the SUPERMAN project that was not yet filmed to invest in for $19.99. The fee was previously charged to his interactive cable system bill. Thereafter, when the film was completed and provided on the system exclusively for viewing, the first producer credit in the normal film credits, selectively, is inserted digitally.

Preferably, a central computing device (e.g., a server computer) has a database of stored participants the content of the film is selectively affected by the server at the time of viewing, (or when the film is initially “loaded” from a digital store means for viewing by respective participants. In this way, participants receive unique versions of a film that reflect respective participants and based on the participants' interactive viewing devices. Each participant may be prominently listed in producer credits. Preferably, the participant credits match the typeface style that is provided in related credits, or “common credits” remaining unchanged between viewers, the viewer has a visual and impression “bonus” or added value, of appearing to be the only, or one of very few actual producers of the project. This unique incentive furthers the direct input and interactive relationship between the project and each, individual investing in a given project, providing the unique gratification typically reserved only for professional producers, and the like.

Further personalized incentives may involve traveling to film festivals and/or awards shows, for selected investors (perhaps determined by contest means). Linking by impression the participants with the projects as closely as typical investors are, with their projects, is selectively significant to proper promotion.

Preferably, participants provide data in response to films and other entertainment projects, thereby educating reedits, project viability and other aspects of entertainment projects typically reserved for focus groups and other marketing measures. Typically, extracting such data in the prior art is costly, requiring individualized efforts. The immediacy of the data provided by home participants is a significant advantage of the present invention, thereby allowing for quantity, quality and speed of information related to consumer preferences and interest. Whether by way of interactive satellite television, cable television, Internet or other basis, the involvement of the viewers in the creative process prior to final completion and/or distribution provides layered benefit.

Further, completed projects may be enhanced and/or improved by education provided by viewer feedback and/or financing on the front end, or between production and distribution, thereby increasing the value of a project to a prospective distribution channel. By encouraging data and/or degree of financial support, (perhaps providing a dowry or “war chest” of money with the project for marketing or other steps typically expensive in the distribution process) a project is more likely to be “picked up” by a distribution channel and brought to market.

In general the venue and invention allow projects to be affected by audience opinion, through computer based interactivity, allowing such input to selectively affect the content of the project(s) and selectively providing funding for the projects. Funding typically requiring risk by investors on the front end, who often end up incurring losses due to the unpredictable nature of film and other projects, as “subjective” and variable products creative artistically. Further the venue, system and method broadens potentially the range of artistic projects that do get produced, their risk being minimized in some cases, by the money collected up front by interested viewers/investors. The audience data collected further (or alone) demonstrates aspects of project viability, or project need, that otherwise might affect revenue or distribution potential of a project/film.

Further, the content provider and service provider (be it cable, internet or other,) has computing means to provide such and to manage the interactive data and related accounting and collating, etc., notifications, automatic insertion of data related to participant end user, when he receives version(s) of “his” project as completed (if completed,) even in rough cut or final form.

The end user has computing means for providing and receiving interactive data, including content, (be it a cable box, or internet computing set up.) they are connected via coaxial or fiber optic cable (or the equivalent) or by internet connection means, (broadband, etc.,) to allow for the dialogue and interactivity.

Moreover, by referencing the hardware and software links, the method can be implemented with software/program for providing video content, such as for editing a feature film, wherein a participant (end user's) name has automatically been factored into the appropriate type face, size and look to be added to a specially prepared “area” in the. project, allowing “custom producer credits” to be provided uniquely to all participating end users, as a software function of providing the video/audio content related to a project after the project is edited. Thus, the present invention comprises automatic editing software feature to generate the associated credits.

The present invention is now described with reference to an example.

IFC Films proposes twelve entertainment projects and provides promotional media in the form of trailers that feature proposed stars and talent who are either performing or provided in other ways to the art, such as by conveying the story, potentially the music, and other related promotional media.

The promotional media are featured on a menu 102 by CABLEVISION cable television provider and selectively on internet web sites as well. By providing the menu 102 on the internet, non-cable subscribers can access and participate in the program. And, such reach beyond the normal confines of cable television increases the likelihood of incentives provided to cable television or internet subscribers of that particular system, i.e., CABLEVISION in the present example. This provides other benefit to the company by reaching beyond their typical service areas and even foreign jurisdictions.

Continuing with reference to the present example, a participant views a plurality of promotional media related to various potential film projects. Thereafter, the participant selects a project he believes has the highest potential or holds the most interest for him, and a $9.99 fee is added to the viewer's monthly cable television bill. In case the project is produced, the viewer has virtually unlimited access to the film or other project on the cable television account they subscribe to; selectively credit to the account of an agreed (flat) credit, or a variable credit, based on the performance of the project, might allow potentially for a large offset of cable charges, should the project be very lucrative for the producers of it.

Various features are now further described.

As noted above, viewer feedback is provided in addition to financing options. Preferably, simple test questions are provided to determine that participants did in fact view a promotional media. Immediate marketing testing data that may lead to distribution, for example, in theaters, of such projects provides is invaluable to producers and distributors. The industry's fear in the prior art to produce “risky” projects, with significant front-end investment is removed in accordance with the teachings herein. Instead, projects are funded and/or produced with critical market data and feedback fueling potential theatrical distribution.

Thus, the present invention provides a new sort of film festival, providing a powerful, new distribution and proprietary focus-group and project/market testing features. Projects/films (for example with $5 mm budgets) can be financed all, or in part, very rapidly in accordance with the teachings herein. Various benefits of the invention include new subscriber incentives and additional spending by subscribers, for example using credit from projects that were never produced. Further, producers/distributors receive exclusive and immediate test marketing information that providing accurate and fast feedback on a variety of completed and potential entertainment (or other) projects. Further, up front financing for films/projects not yet produced can be driven, and information resulting from testing and confirming audience reaction to projects, informing revision and/or overall viability is provided.

Further, participants benefit by gaining direct input and interactivity with programming and what “gets made” and distributed. Further, participants receive exclusive viewing rights on a completed project that is “co-produced” by the participant. Further, participants can enjoy viewing their names on one of the credit slates within the film, as if it occurs on the versions all people see. Moreover, participants may enjoy a return on investment, potentially many fold, as distributors credit, toward future pay-per-veiw view or other options. Moreover, those promotional media that are sponsored by participants and not ultimately produced are preferably returned to the PAY-PER-VIEW credit of that participant's account for other options, eliminating risk. Other incentives are envisioned, such as a potential to win trips to festivals, awards shows and the like for winning projects that subscribers sponsored, to share the rewards of their own foresight and artistic taste.

In another embodiment, a plurality of potential incentives and benefits is provided to “home producers,” or those end users who choose to participate at least with providing feedback data through the interactive features, and/or financial participation (for example in paying a fee on a selected basis, related to participating in a selected potential project the end user has selected). One powerful incentive is variable home producer credits. Specifically, within projects, such as an independent feature film, electronic version(s) of edit(s) of the project(s) are addressable to change at least one “credit,” which refers to the name listings typical to the beginning and end of motion pictures, related to those who worked on the project.

The on-demand and otherwise individually addressable technology provided by cable television today, for example, allow for this to be an automatic option when empowered by software program or programs of the present invention specific to this purpose. Such software preferably maintains the artistic aspects or “look” of other credits that are universally provided. In other words, those credits that occur in every version of that edited piece and made accessible to any viewers of it have artistic aspects or a look that is maintained in the changed credit, and with a varying of the outgoing, for example, digital video data aspect of the media. This allows a credit to uniquely reflect, for example, the name of a specific “home producer,” (a person selectively choosing to be involved in the potential project to which this variable credit will be affected with that person's name.) The special viewing rights selectively provided to such “home producers,” (the potential project funders under the present invention,) would thus be made further special, as the very “media” or provided (or at least accessible) to the specific end user's “cable box” would alone feature the end result of that end user's, or “home producer's,” actual name as placed seamlessly and with matching artistic impression, within the main body of project credits. In essence, for example, a man in Ohio who chooses to pay $29.99 to “home produce” an independent feature film not yet shot that he believes from the promotional media (or potential project “teaser,” represented by an icon on screen and likely a short video and audio demo) may at least reward him with incentive(s) and/or provide a benefit acceptable to this man in Ohio to become associated with this project. To the man in Ohio, it is more like “pay per view” that he pays for in advance, and will see later, with the benefit of also being treated like a real producer, etc.

With the inclusion of the specific software unique to this invention, a cable system's (or internet site's) media distributing hardware can quite simply apply the automatic alteration, informed by the external media provided by the system related to the “home producer” involved and his or her name, before providing or opening up that piece of media for access (selectively) by only that “home producer's” cable box(s) and/or identification, if a web site. Though, it is important to say, that these uniquely tailored films and related entertainment media as provided, need not be restricted to these two examples. Herein, potentially thousands and even millions of unique “versions” of a single edited project version is the issue, allowing many “end users” or viewers, to fund and/or otherwise participate in projects and receive potentially this (customized producer credit, coming on screen before any other universally listed producers appear, for example,) and/or other incentives, including potentially money, or credit on their cable bill for projects that succeed, or the like.

Thus, in accordance with the teachings herein, the present invention provides a unique focus group data sampling opportunity with immediate response that allows entertainment project makers to gauge/modify projects in progress. Further, the invention provides a way for producing potential entertainment and other projects, while simultaneously providing incentives for various home viewers to invest in such projects. Although the present invention has been described in relation to particular embodiments thereof, many other variations and modifications and other uses will become apparent to those skilled in the art. It is preferred, therefore, that the present invention be limited not by the specific disclosure herein.

What is claimed:

1. A method for receiving a financial contribution for a project from a plurality of participants in an interactive offering, the method comprising:
generating promotional media that demonstrates the project;
providing the promotional media to at least one of the participants and demonstrating the project to the at least one participant as a function of the promotional media;
providing a selectable control in a display screen over a communication network that when selected represents the at least one participant's indication to make a financial contribution to the fees for the project;
receiving from the at least one participant the financial contribution; and
providing an incentive to the at least one participant for making the financial contribution, wherein the financial contribution is applied to the project.

2. The method of claim 1, further comprising providing the at least one participant with access to the project when the project is completed.

3. The method of claim 2, wherein the access is exclusive to the at least one participant.

4. The method of claim 1, further comprising providing the at least one participant with access to the project prior to completion of the project.

5. The method of claim 1, wherein the incentive is at least one selected from the group consisting of:
money;
a credit in a paid television account;
a credit in an internet service account;
a share in proceeds generated by the project;
exclusive viewing rights;
insertion of the at least one participant's name in the project's credits; and
free travel.

6. The method of claim 1, wherein the promotional media is a sequence of visuals coupled with audio content and showcases attributes of the project.

7. The method of claim 1, further comprising reimbursing the at least one participant at least some of the financial contribution in case the project is not produced or distributed.

8. The method of claim 1, wherein the project is at least one selected from the group consisting of a movie, a television program, a musical event, a new product offering, a new service offering and a theatrical performance.

9. The method of claim 1, wherein the display screen is viewable in an internet web browser software application.

10. The method of claim 1, further comprising receiving feedback from the at least one participant represent the at least one participant's impression of the project.

11. The method of claim 10, further comprising modifying the project in response to the feedback.

12. The method of claim 1, wherein the financial contribution is incurred in the at least one participant's paid television service bill.

13. The method of claim 1, wherein the financial contribution is incurred in the at least one participant's internet access service bill.

14. The method of claim 1, wherein the at least one participant's provider of paid television service generates the promotional media.

15. A system for receiving financial sponsorship for a project from a plurality of participants in an interactive offering, the system comprising:
promotional media that demonstrates the project, wherein the promotional media is distributed to at least one of the participants and further wherein the promotional media demonstrates the project to the at least one participant;
a computing device operating over a communication network that provides an interactive display screen for the plurality of participants;
at least one selectable control in the interactive display screen that when selected represents the at least one participant's indication to make a financial contribution to the project;
a financial reception module operable to receive from the at least one participant the financial contribution; and
an incentive providing module operable to provide an incentive to the at least one participant for making the financial contribution.

16. The system of claim 15, wherein the at least one participant is provided access to the project when the project is completed.

17. The system of claim 16, wherein the access is exclusive to the at least one participant.

18. The system of claim 15, wherein the at least one participant is provided with access to the project prior to completion of the project.

19. The system of claim 15, wherein the incentive is at least one selected from the group consisting of:
money;
a credit in an account;
a share in proceeds generated by the project;
exclusive viewing rights;
insertion of the at least one participant's name in the project's credits; and
free travel.

20. The system of claim 15, wherein the promotional media is a sequence of visuals coupled with audio content and showcases attributes of the project.

21. The system of claim 15, wherein the at least one participant is reimbursed at least some of the financial contribution in case the project is not produced or distributed.

22. The system of claim 15, wherein the project is at least one selected from the group consisting of a movie, a television program, a musical event, a new product offering, a new service offering and a theatrical performance.

23. The system of claim 15, further comprising a feedback module operable to receive feedback from the at least one participant representing the at least one participant's impression of the project.

24. The system of claim 23, further wherein the project is modified in response to the feedback.

25. The system of claim 15, wherein the financial contribution is incurred in the at least one participant's paid television service bill.

26. The system of claim 15, wherein the financial contribution is incurred in the at least one participant's internet access service bill.

27. The system of claim 15 wherein the at least one participant's provider of paid television service generates the promotional media.

28. A method for receiving financial backing for a potential project from a plurality of participants in an interactive offering, the method comprising:
generating promotional media that demonstrates the potential project;
providing the promotional media to at least one of the participants and demonstrating the potential project to the at least one participant as a function of the promotional media;
providing a selectable control in a display screen over a communication network that when selected represents the at least one participant's indication to participate in a selected potential project, said indication to participate at least involving said participant providing creative feedback or a commitment to pay a selected amount in relation to said potential project;
providing an incentive to the at least one participant for participating in said potential project, wherein fees paid by the at least one participant at least in part provides funding for the realization of the potential project.

29. A system for providing customized name credits within media content, the customized name credits representing at least one individual end user who participated in a project related to the media content, the system comprising:
a media content source providing at least a portion of the media content;
visible name credits provided in the media content source and provided by the media content source, wherein the visible name credits represent participants involved in the production of aspects of the project,
at least one variable name credit provided by a data source separate from the media content source, wherein the variable name credit represents the at least one individual end user; and
a computing device operable to generate the customized name credits by applying at least artistic aspects of the visible name credits to the at least one variable name credit, wherein the computing device provides the media content with the customized name credits.

30. The system of claim 29, wherein the artistic aspects relate at least to type point size and font.

31. A method for providing customized name credits within media content, the customized name credits representing at least one individual end user who participated in a project related to the media content, the system comprising:
providing a media content source for at least a portion of the media content;
providing visible name credits in the media content source from the media content source, wherein the visible name credits represent participants involved in the production of aspects of the project,
providing at least one variable name credit by a data source separate from the media content source, wherein the variable name credit represents the at least one individual end user; and
generating on a computing device the customized name credits by applying at least artistic aspects of the visible name credits to the at least one variable name credit, wherein the computing device provides the media content with the customized name credits.
